(19) United States
(12) Patent Application Publication
(10) Pub. No.: US 2013/0240401 A1
(43) Pub. Date: Sep. 19, 2013

(54) STACKABLE, POURABLE PRODUCT CONTAINER

(71) Applicant: Charles E. Hall, Wentzville, MO (US)

(72) Inventor: Charles E. Hall, Wentzville, MO (US)

(73) Assignee: Buddeez, Inc., Wentzville, MO (US)

(21) Appl. No.: 13/422,265

(22) Filed: Mar. 16, 2012

(51) Int. Cl. B65D 21/032; B65D 6/40; B65G 57/03; B65D 8/12

(52) U.S. Cl. 206/509; 220/669; 220/608; 220/601; 414/802

(57) ABSTRACT

A plastic blow molded pourable product container is constructed to support the combined weight of additional like containers stacked on top of the container, and is also constructed to efficiently use a three dimensional space occupied by a stack of containers and to resist relative movement between adjacent containers assembled together in a three dimensionally arrayed stack of the containers.

### FIELD

The present invention pertains to a plastic container that is constructed to support the combined weight of additional like containers stacked on top of the container, and is also constructed to efficiently use a three dimensional space occupied by a stack of the containers and to resist relative movement between adjacent containers assembled together in a three dimensionally arrayed stack of the containers.

### BACKGROUND

Pourable product containers, for example plastic blow molded one gallon liquid containers used to transport liquid products such as milk and fruit juices, or pourable granular products such as salt or pet food from a product producer to a product retailer have for some time been associated with the problem of transporting the product containers efficiently.

Efficient transport of product containers basically requires that as many containers as possible be fit into the smallest area for transporting. For example, containers such as cardboard or paperboard boxes containing goods are typically arranged in a tight fit three dimensional array on a pallet surface to efficiently transport the boxes. A tight fit two dimensional array of boxes is arranged as a bottom layer of boxes on the pallet surface. Additional tight fit two dimensional arrayed layers of boxes are stacked on top of the bottom layer. This results in a three dimensional tight fit arrangement of boxes on the pallet that can be efficiently transported.

With pourable product containers such as plastic blow molded gallon containers or bottles, it is not possible to fully employ the same technique of arranging a three dimensional stack of boxes on a pallet. Conventional plastic blow molded containers do not have a sufficient structural strength to support the weight of additional blow molded plastic containers, one on top of another.

There is a need for a plastic blow molded one gallon container construction that is sufficiently structurally strong to support the combined weight of additional stacked containers while also efficiently using a three dimensional space occupied by a three dimensional array of the containers.

### SUMMARY

The pourable product container of the present invention overcomes the disadvantages associated with plastic blow molded liquid containers by providing a plastic blow molded pourable product container with a structure that is sufficiently strong to support several like containers stacked on top of the container. In addition, the container of the present invention is provided with a novel construction that enables a plurality of the containers to be arranged in a tightly packed, space efficient two dimensionally arrayed layer. The container construction resists relative movement between adjacent containers in the two dimensionally arrayed layer of the containers and resists relative movement between adjacent containers in a stack of the containers.

The pourable product container of the invention is a plastic blow molded one gallon container. However, the concepts of the invention can be employed in other sizes of plastic containers. The container has a general cubic configuration with a rectangular or square top surface, a rectangular or square bottom surface and four side surfaces that extend between the top surface and bottom surface.

The top surface has a cylindrical neck that surrounds an opening to the interior of the container. A substantially flat surface area of the top surface surrounds the neck. The neck is centered in the top surface.

The bottom surface has at least one cylindrical interior wall that is recessed into the bottom surface. The cylindrical interior wall surrounds a cavity that is centered in the bottom surface. A substantially flat surface area of the bottom surface surrounds the cavity. The cavity is dimensioned to receive the container neck of a lower container when the substantially flat bottom surface area of an upper container is positioned on top of the substantially flat top surface area of the lower container. The neck of the lower container fits into the cavity of the upper container and provides a connection between the stacked containers that allows for only limited relative side to side movement between the upper and lower containers.

Two of the four side surfaces of the container are constructed with pluralities of concave groove surface sections. The concave groove surface sections have lengths that extend between the container top surface and bottom surface, and widths that are sequentially arranged across each of the two side surfaces of the container. The lengths of the groove surface sections merge with the container top surface and bottom surface, and thereby form each of the two side surfaces as corrugation reinforced structures between the container top surface and bottom surface.

The other two side surfaces of the container are constructed with pluralities of convex rib surface sections. The convex rib surface sections have lengths that extend between the container top surface and bottom surface, and widths that are sequentially arranged across each of the two side surfaces. The lengths of the convex rib surface sections merge with the container top surface and bottom surface, and thereby form each of the other two side surfaces as corrugation reinforced structures between the container top surface and bottom surface.

The convex rib surface sections are complementary to the concave groove surface sections, wherein the convex rib surface sections of one container fit into the concave groove surface sections of a second container. This enables a plurality of the containers to be arranged in a tightly packed, space efficient two dimensionally arrayed layer with the convex rib surface sections and the concave groove surface sections of adjacent containers engaging each other. This enables forming a tight fit two dimensional arrayed layer of the containers on a pallet that resists relative movement between adjacent containers and makes efficient use of the pallet surface. Additionally, the concave groove surface sections and convex rib surface sections of each container in the two dimensionally arrayed layer of containers provide the bottom layer of containers with enhanced structural strength for supporting additional two dimensional arrayed layers of containers stacked on the bottom layer of containers. Furthermore, the necks of each of the containers in the two dimensionally arrayed lower layers engage in the cavities of each of the containers in the two dimensionally arrayed upper layers and limit relative movements between the stacked layers of containers.

The plastic blow molded container of the invention described above has enhanced structural strength to support additional layers of like containers stacked on the container. Furthermore, the construction of the container described above resists relative movement between adjacent containers in a two dimensionally arrayed layer of containers and resists relative movement between containers stacked on each other. Further features of the container of the invention are set forth in the following description of the drawing figures and in the detailed description of the invention.

### BRIEF DESCRIPTION OF THE DRAWING FIGURES

FIG. 1 is an upper perspective view of the stackable pourable product container of the invention.

FIG. 2 is a lower perspective view of the container.

FIG. 3 is an upper perspective view of the container similar to that of FIG. 1, but with the container rotated to the right 90°.

FIG. 4 is an upper perspective view of the container from the opposite side of the container shown in FIG. 1.

FIG. 5 is an elevation view of one side of the container.

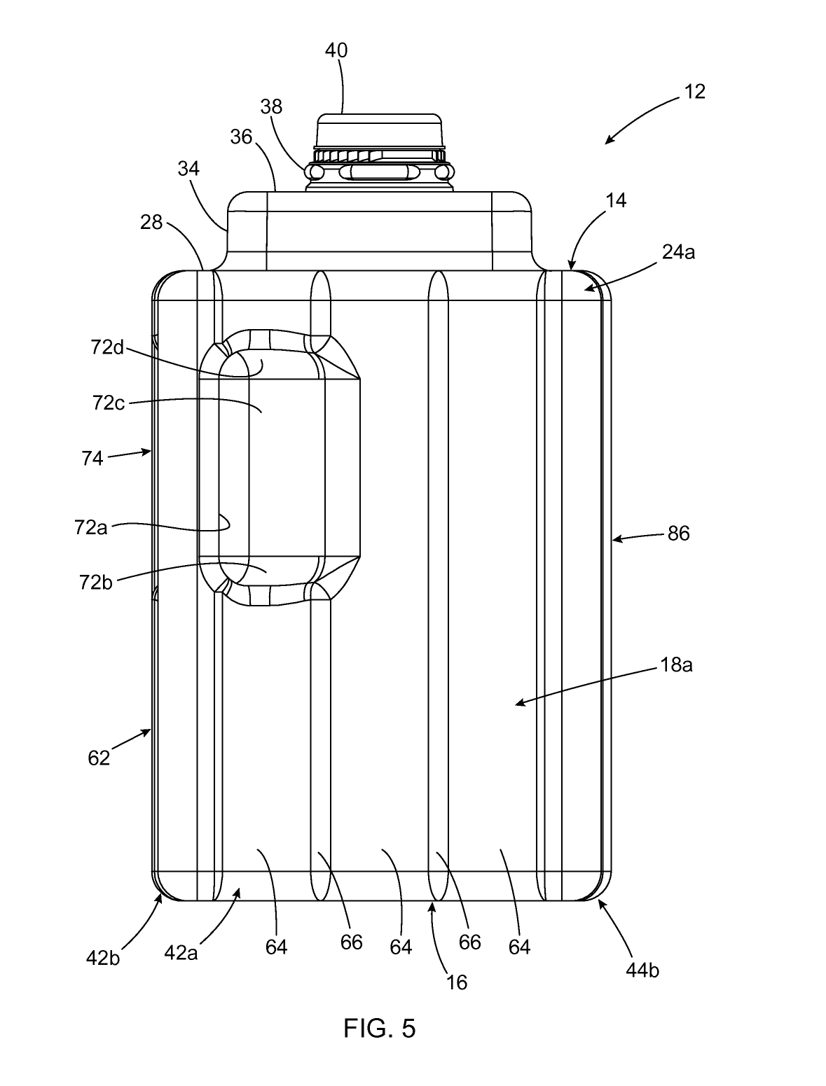

FIG. 6 is an elevation view of another side of the container.

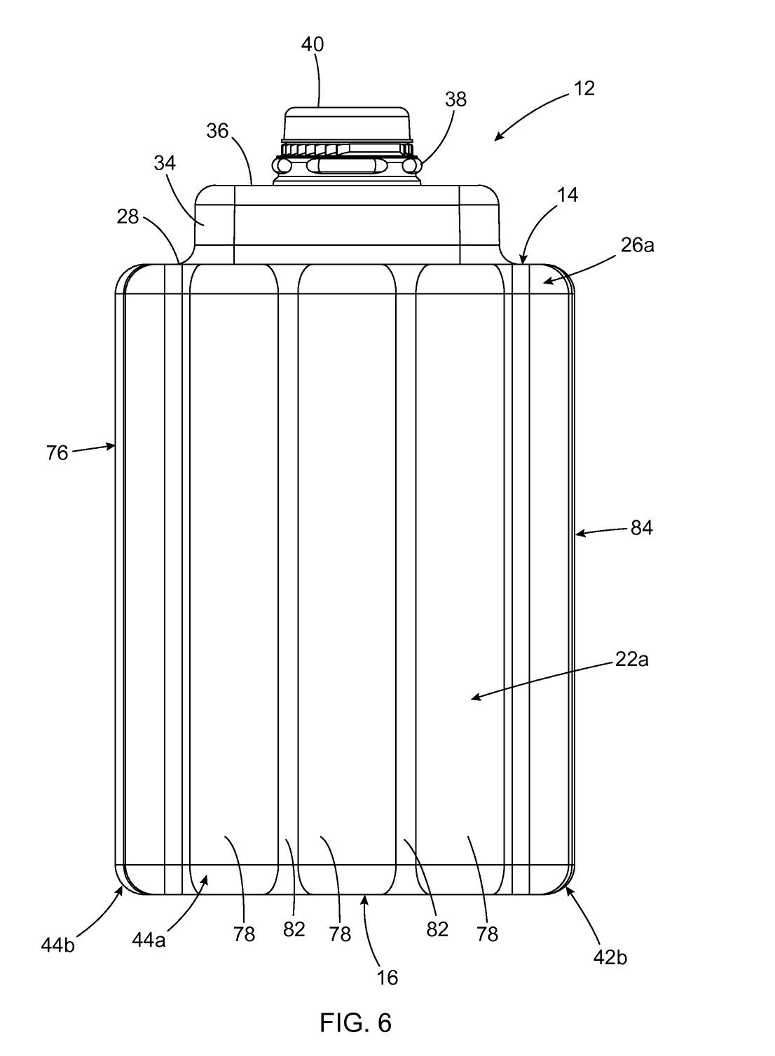

FIG. 7 is a top plan view of the container.

FIG. 8 is a bottom plan view of the container.

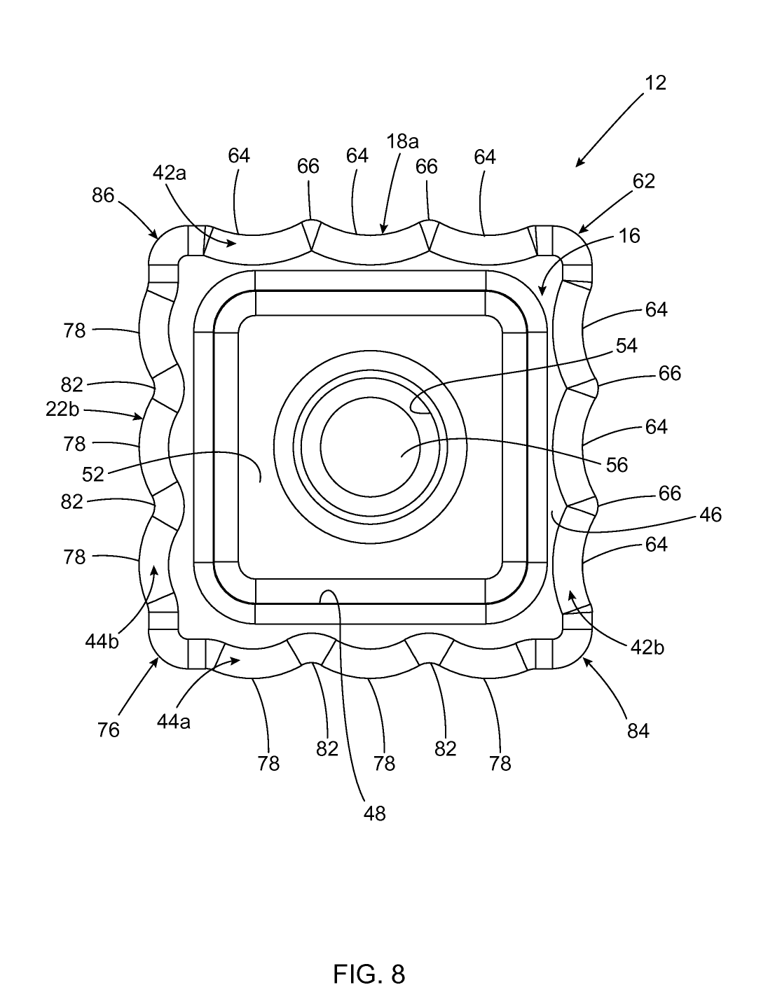

FIG. 9 is an elevation cross section view of two stacked containers.

FIG. 10 is an upper perspective view of two stacked containers.

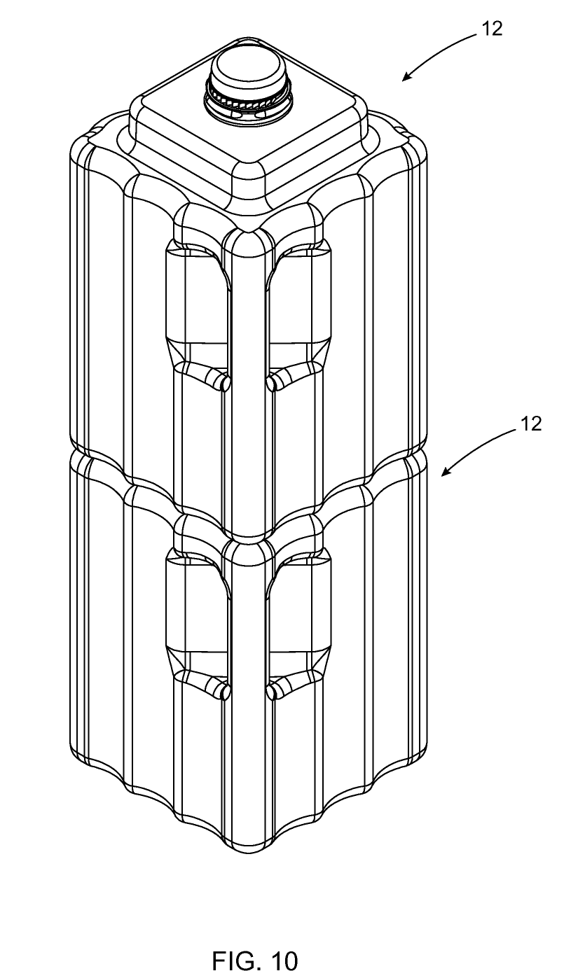

FIG. 11 is a lower perspective view of two stacked containers.

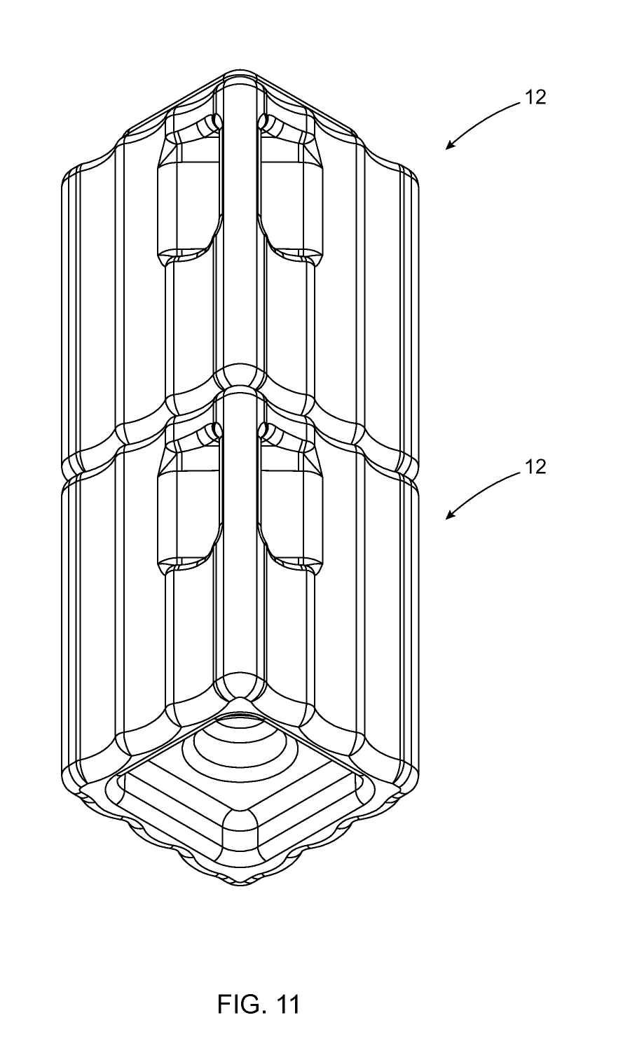

FIG. 12 is a top plan view of a plurality of containers arranged in a tightly packed, space efficient two dimensionally arrayed layer of containers.

FIG. 13 is an elevation view of a side of a three dimensionally arrayed stack of containers.

### DETAILED DESCRIPTION OF THE INVENTION

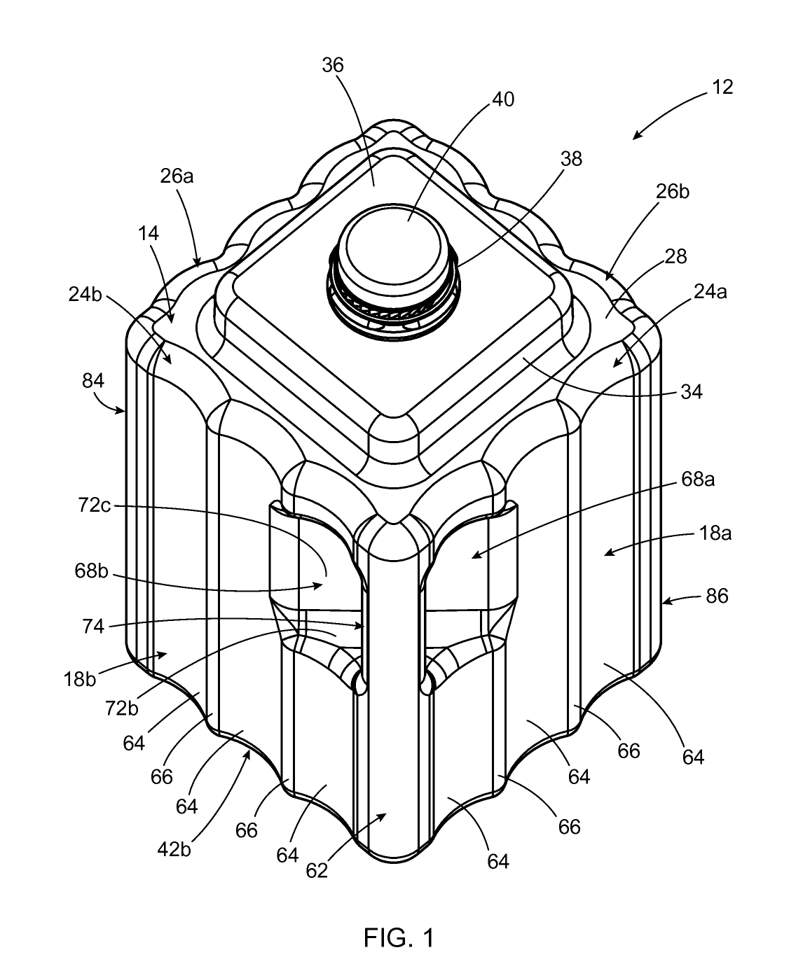

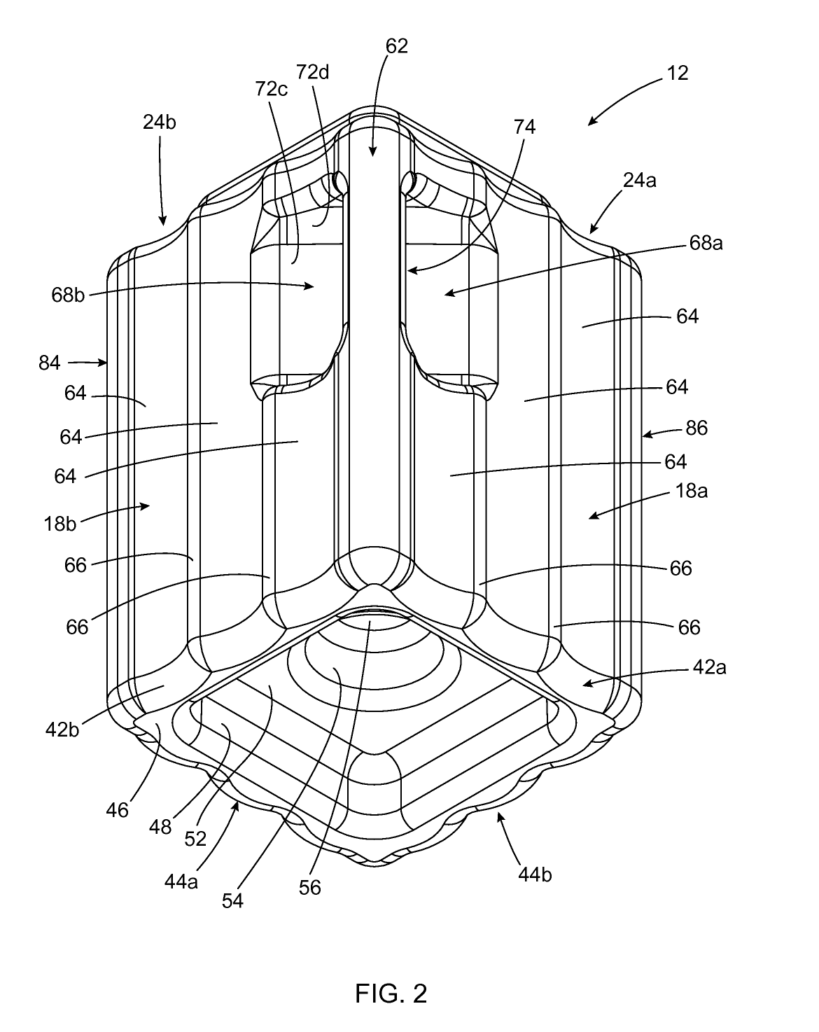

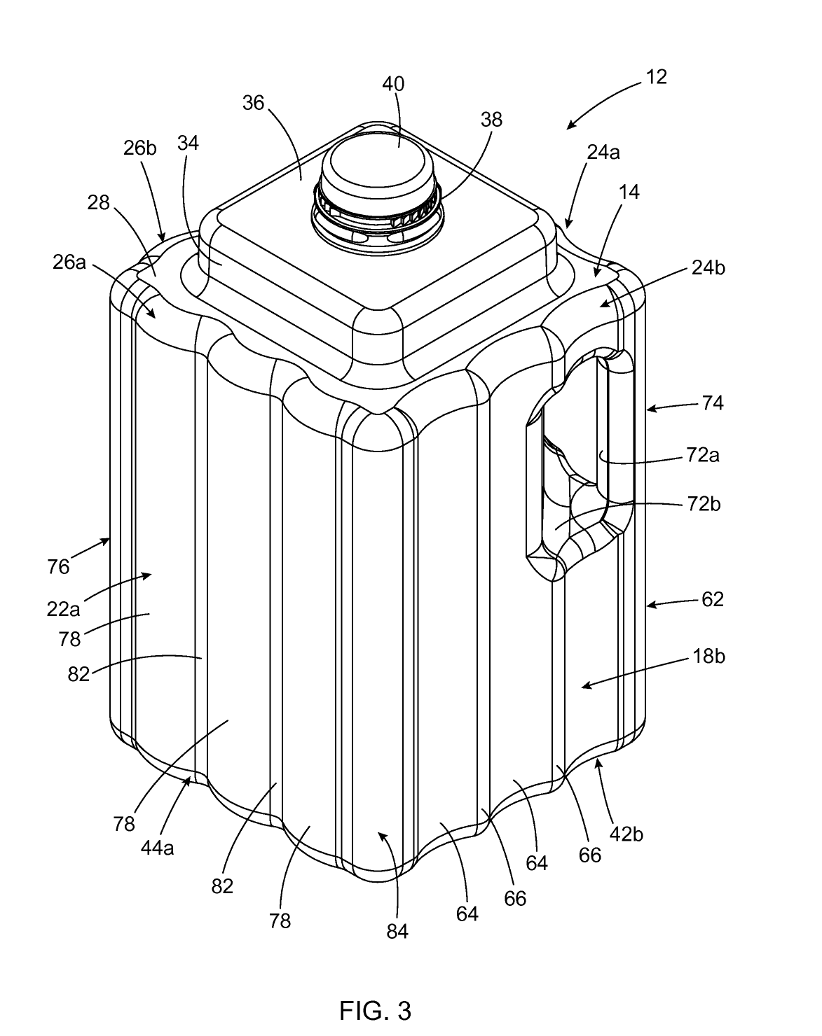

FIGS. 1,2 and 3 show perspective views of opposite sides of the pourable product container 12 of the invention. In the embodiment of the container shown in FIGS. 1, 2 and 3, the container 12 is a plastic, blow molded one gallon bottle. The container or bottle 12 is constructed to contain one gallon of a liquid such as milk or juice, or contain granular products such as salt or pet food. In the illustrated embodiment, the container 12 is constructed as a blow molded plastic container in order to construct the container as cost efficiently as possible. Other manufacturing techniques could be employed in constructing the container 12, as well as other materials. However, because conventional plastic blow molded containers are not particularly structurally strong, the particular construction of the container 12 to be described is well suited for enhancing the structural strength of a plastic blow molded container to enable several product filled containers to be arranged in a vertical stack with the bottom most container in the stack having sufficient structural strength to support the combined weight of the above product containers in the stack.

As seen in the drawing figures, the container 12 has a general cubic configuration that is defined by the combination of the rectangular or square top surface 14, the rectangular or square bottom surface 16 and the rectangular or square four side surfaces 18a, 18b, 22a, 22b. The four side surfaces 18a, 18b, 22a, 22b extend between and merge into the top surface 14 and the bottom surface 16. The side surfaces 18a, 18b are mirror images of each other and therefore only one of the side surfaces 18a will be described in detail. The side surfaces 22a, 22b are mirrored images of each other and therefore only one of the surfaces 22a will be described in detail.

The generally square configuration of the top surface 14 is defined by four top corner surfaces 24a, 24b, 26a, 26b. The top corner surfaces 24a, 24b, 26a, 26b extend around and border the top surface 14. The four top corner surfaces 24a, 24b, 26a, 26b extend across the tops of the respective side surfaces 18a, 18b, 22a, 22b and merge the side surfaces into the top surface 14. As seen in the drawing figures, the top corner surfaces 24a, 24b, 26a, 26b are rounded surfaces that form a smooth transition between the top surface 14 and the four side surfaces 18a, 18b, 22a, 22b. The top surface 14 has a substantially flat surface area 28 that is bounded by the four top corner surfaces 24a, 24b, 26a, 26b. The flat surface area 28 surrounds cube-shaped walls 34 that project upwardly from the center of the flat surface area 28. The cube-shaped walls 34 extend upwardly from the flat surface area 28 and merge smoothly into a substantially flat square surface 36. A cylindrical container neck 38 extends upwardly from the center of the square surface 36. The neck 38 surrounds an opening to the container interior. A cylindrical cap 40 is screw threaded onto the neck 38. The cap 40 selectively closes and opens the opening to the container interior. Other equivalent types of closure devices could be used with the container 12 in place of the cap 40. Additionally, in other embodiments the cube-shaped walls 34 could be a cylindrical wall and the square surface 36 could be annular.

The container bottom surface 16 also has a general square configuration defined by four bottom corner surfaces 42a, 42b, 44a, 44b that extend around and border the bottom surface 16. The bottom corner surfaces 42a, 42b, 44a, 44b extend across the bottoms of the respective side surfaces 18a, 18b, 22a, 22b and merge the side surfaces into the bottom surface 16. As seen in the drawing figures, the bottom corner surfaces 42a, 42b, 44a, 44b are rounded surfaces that smoothly transition the bottoms of the four side surfaces 18a, 18b, 22a, 22b into the bottom surface 16. The four bottom corner surfaces 42a, 42b, 44a, 44b surround and form a border around a substantially flat surface area 46 of the bottom surface 16. Cube-shaped interior walls 48 are centered in the flat surface area 46 and extend into the container interior from the flat surface area 46. The interior cross section dimensions of the interior walls 48 are slightly larger than the exterior cross section dimensions of the cube-shaped walls 34 that project from the flat surface area 28 of the top surface 14. The interior walls 48 extend to a substantially flat square surface 52. The area of the square surface 52 on the bottom surface 16 is slightly larger than the area of the flat square surface 36 on the top surface 14. A cylindrical interior wall 54 extends into the container interior from the square surface 52 on the bottom surface 16. The cylindrical interior wall 54 is centered in the square surface 52 and extends into the container interior to a substantially flat circular surface 56. The interior diameter dimension of the cylindrical interior wall 54 is slightly larger than the exterior diameter dimension of the cap 40 and the neck 38 on the container top surface 14.

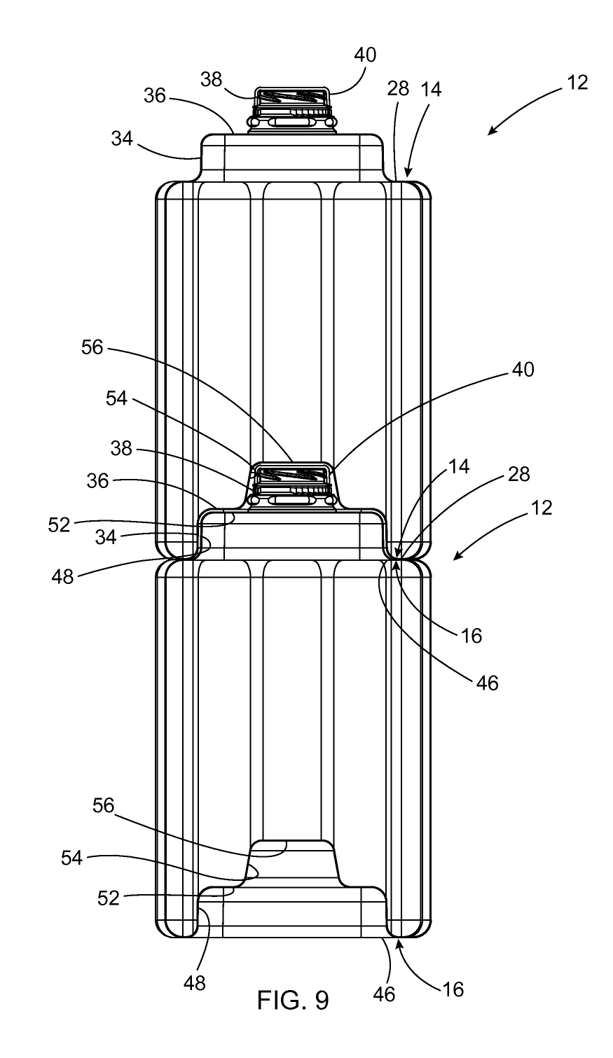

With the cube-shaped interior walls 48 on the bottom surface 16 dimensioned just slightly larger than the cube-shaped walls 34 on the top surface 14 and with the cylindrical interior wall 54 dimensioned just slightly larger than the container neck 38 and the cap 40, the bottom surface 16 of one container can be positioned on the top surface 14 of a second container as shown in FIG. 9 with the cube-shaped walls 34, neck 30 and cap 40 of the second container fitting easily inside the respective cube-shaped interior walls 48 and cylindrical interior wall 54 of the one container. With the bottom flat surface area 46 of the one container engaged and being supported on the top flat surface area 28 of the second container, the cube-shaped walls 34, neck 30 and cap 40 of the bottom container allow only limited movement of the top container relative to the bottom container. In other embodiments, the cube-shaped interior walls 48 could be cylindrical and the square surface 52 could be circular.

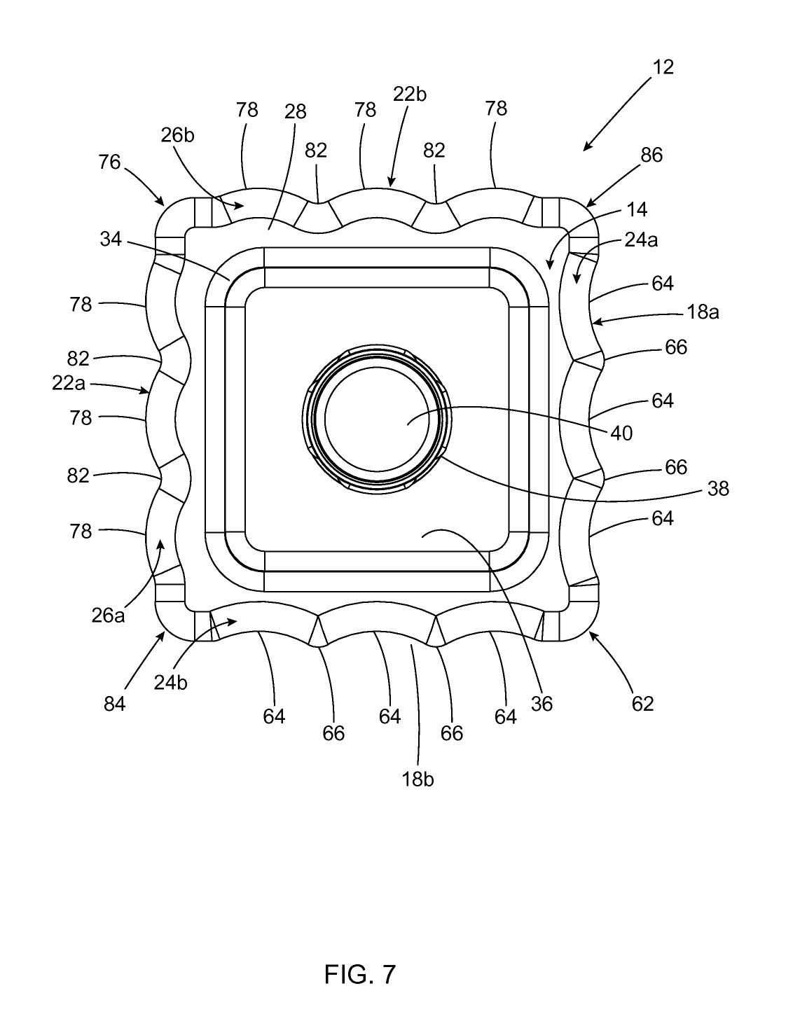

Two adjacent side surfaces 18a, 18b of the four side surfaces merge smoothly together at a rounded side corner surface 62 that extends between the top surface 14 and bottom surface 16. The top end of the side corner surface 62 merges smoothly into adjacent ends of the top corner surface 24a and the top corner surface 24b. The opposite, bottom end of the side corner surface 62 merges smoothly into adjacent ends of the bottom corner surface 42a and of the bottom corner surface 42b. As stated earlier and as best seen in FIG. 1, the side surfaces 18a, 18b on opposite sides of the corner surface 62 are mirror images of each other. Each of the surfaces 18a, 18b is constructed with pluralities of concave groove surface sections 64. The concave groove surface sections 64 are substantially parallel and have lengths that extend between the top surface 14 and the bottom surface 16 and have widths that are sequentially arranged completely across the two side surfaces 18a, 18b of the container. The lengths of the groove surface sections 64 merge smoothly into the top corner surfaces 24a, 24b and into the bottom corner surfaces 42a, 42b, and thereby form each of the side surfaces 18a, 18b as corrugation reinforced structures between the top surface 14 and the bottom surface 16. As seen in FIG. 7, the lengths and widths of the groove surface sections 64 occupy a majority of the areas of the side surfaces 18a, 18b. Only narrow peaks or ridges 66 formed where adjacent groove surface sections 64 meet separate adjacent groove surface sections from each other. Like the groove surface sections 64, the peaks or ridges 66 are substantially parallel and extend along the lengths of the groove surface sections 64 between the top surface 14 and bottom surface 16. The peaks or ridges 66, like the concave groove surface sections 64 function as corrugation reinforcement structures on the side surfaces 18a, 18b.

Rectangular openings 68a, 68b are formed in the two side surfaces 18a, 18b. As shown in the drawing figures, the openings 68a, 68b are positioned adjacent the top corner surfaces 24a, 24b and are separated by the side corner surface 62. The generally rectangular openings 68a, 68b are connected together by channel surfaces 72a-d that extend through the interior of the container 12 between the two openings 68a, 68b. The channel surfaces 72a-d form a passageway through the container 12 that is dimensioned to allow the fingers of a user's hand to easily pass through the passageway. Together the openings 68a, 68b and the channel surfaces 72a-d form a handle 74 on the side corner surface 62 of the container.

The other two adjacent side surfaces 22a, 22b merge smoothly together at a rounded side corner surface 76 between the two surfaces. A top end of the side corner surface 76 merges smoothly into adjacent ends of the top corner surface 26a and the top corner surface 26b. A bottom end of the side corner surface 76 merges smoothly into adjacent ends of the bottom corner surface 44a and the bottom corner surface 44b.

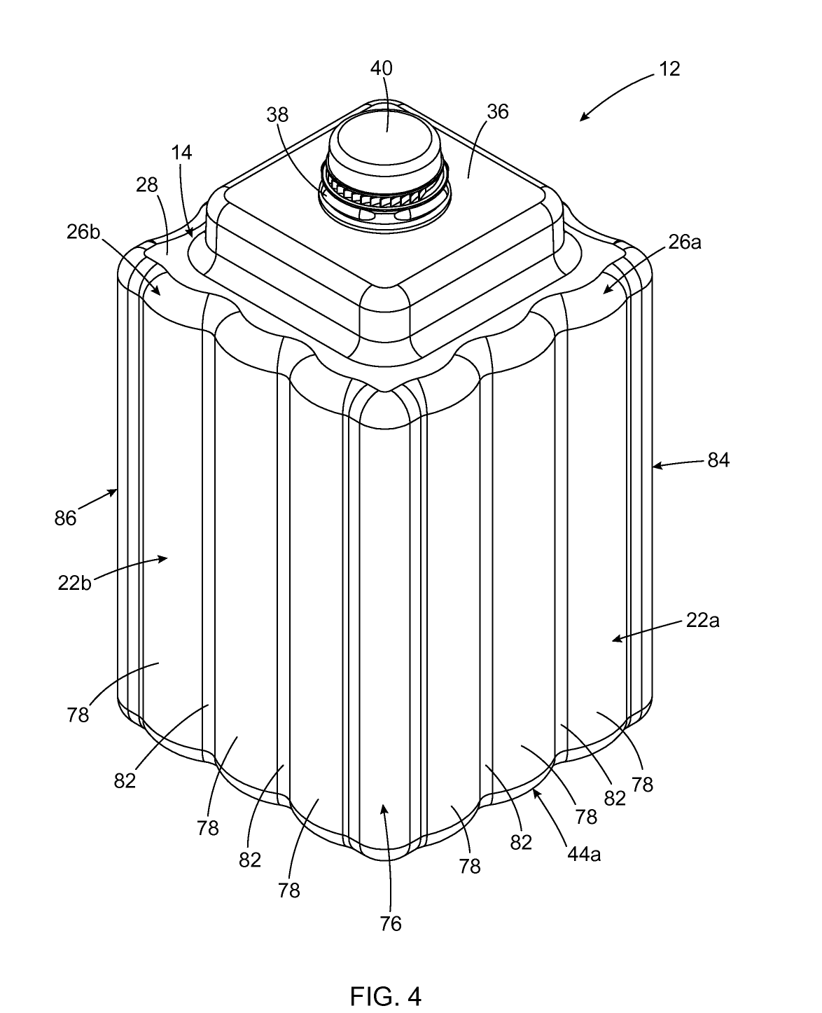

As stated earlier and as best seen in FIG. 4, the other two side surfaces 22a, 22b on opposite sides of the corner surface 76 are mirror images of each other. Each of the side surfaces 22a, 22b is formed with pluralities of convex rib surface sections 78. The convex rib surface sections 78 are substantially parallel and have lengths that extend between the container top surface 14 and bottom surface 16, and widths that are sequentially arranged completely across the two side surfaces 22a, 22b of the container. The top ends of each of the rib surface sections 78 on the side surfaces 22a, 22b merge smoothly into the respective top corner surfaces 26a, 26b and thereby merge smoothly with the flat surface area 28 of the top surface 14. The bottom ends of each of the rib surface sections 78 on the side surfaces 22a, 22b merge smoothly into the respective bottom corner surfaces 44a, 44b and thereby merge smoothly into the flat surface area 46 of the bottom surface 16. The lengths of the rib surface sections 78 form each of the two side surfaces 22a, 22b as corrugation reinforced structures extending between the top surface 14 and the bottom surface 16. The lengths and widths of the rib surface sections 78 occupy a majority of the areas of the side surfaces 22a, 22b. Only narrow slots or valleys 82 formed where adjacent rib surface sections 78 meet separate adjacent rib surface sections from each other. Like the rib surface sections 78, the slots or valleys 82 are substantially parallel and extend along the lengths of the rib surface sections 78 between the top surface 14 and the bottom surface 16. The slots or valleys 82, like the rib surface sections 78 function as corrugation reinforcement structures on the side surfaces 22a, 22b.

As shown in FIGS. 1-4, the two adjacent side surfaces 18a, 18b and the two adjacent side surfaces 22a, 22b merge smoothly together at two additional rounded side corner surfaces 84, 86 that extend between the top surface 14 and the bottom surface 16. The top end of the side corner surface 84 merges smoothly into adjacent ends of the top corner surface 24b and the top corner surface 26a. The opposite bottom end of the side corner surface 84 merges smoothly into adjacent ends of the bottom corner surface 42b and the bottom corner surface 44a. The top end of the side corner surface 86 merges smoothly into adjacent ends of the top corner surface 24a and the top corner surface 26b. The opposite bottom end of the side corner surface 86 merges smoothly into adjacent ends of the bottom corner surface 42a and the bottom corner surface 44b.

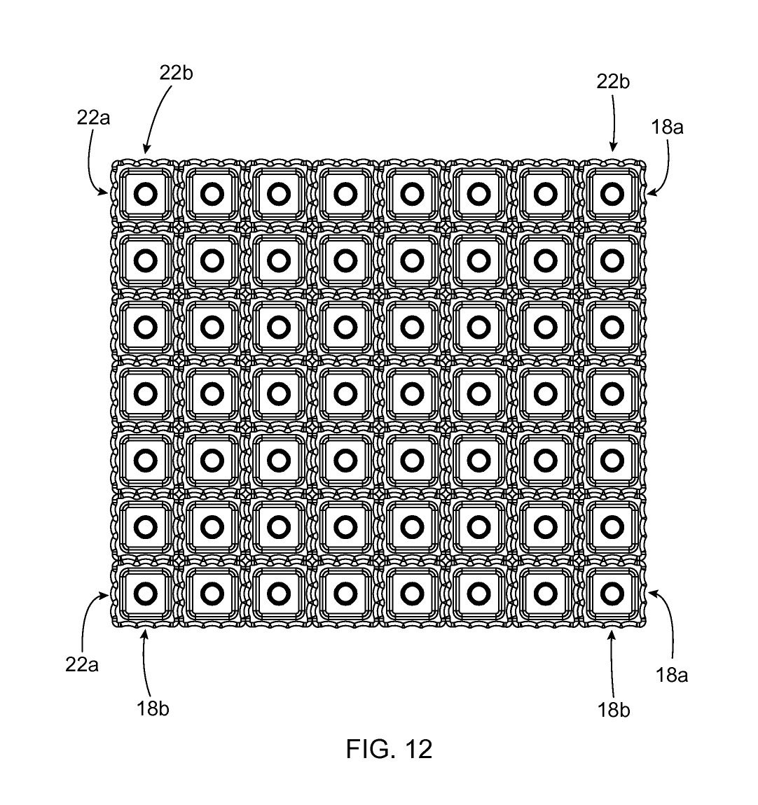

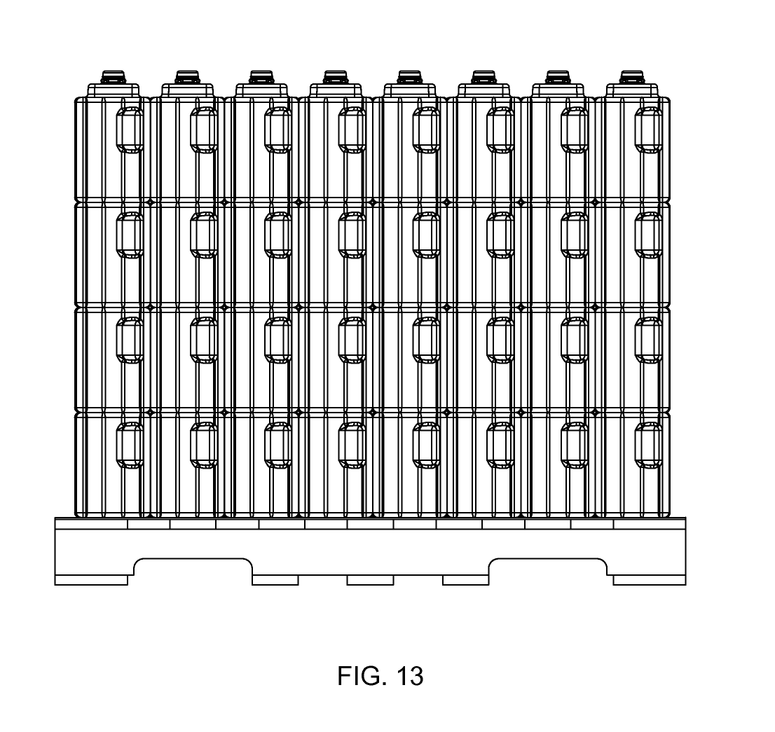

The convex rib surface sections 78 are complementary to the concave groove surface sections 64. The convex rib surface sections 78 of one container fit into the concave groove surface sections 64 of a second container. This enables pluralities of containers 12 to be arranged in a two dimensional array as shown in FIG. 12 with the convex rib surface sections 78 and the concave groove surface sections 64 of adjacent containers engaging each other. In this manner a tight fit two dimensional arranged layer of containers 12 can be formed on a pallet surface with the engagement between the side surfaces 18a, 18b, 22a, 22b of adjacent containers resisting relative movement between the containers and also making efficient use of the surface area of the pallet. Additionally, the concave groove surface sections 64 and convex rib surface sections 78 of the containers in the two dimensionally arranged layer of containers provide the bottom layer of containers with enhanced structural strength for supporting additional two dimensionally arrayed layers of containers stacked on the bottom layer of containers as shown in FIG. 13. Furthermore, the necks of the two dimensionally arrayed containers 12 in the lower layers engage in the cavities of the upper layers of two dimensionally arranged layers of containers as shown in FIG. 9 and resist relative movement between the stacked layers of containers.

The plastic blow molded container 12 of the invention described herein has enhanced structural strength to support additional layers of like containers stacked on the container. Furthermore, the construction of the container described herein resists relative movement between adjacent containers in a two dimensionally arranged layer of containers and resists relative movement between containers stacked on each other.

As various modifications could be made in the construction of the container of the invention herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above described exemplary embodiments, but should be defined only in accordance with the following claims appended hereto and their equivalents.

1. A pourable product container comprising:
a top surface having a substantially flat surface area;
a bottom surface having a substantially flat surface area that is opposite and substantially parallel with the top surface flat surface area;
a plurality of side surfaces that extend between the top surface and the bottom surface and merge into the top surface and the bottom surface, at least a first of the side surfaces having a plurality of concave groove surface sections having lengths that extend substantially straight and parallel between the top surface and the bottom surface and having widths that are arranged side by side across the first side surface, and at least a second of the side surfaces having a plurality of convex rib surface sections having lengths that extends substantially straight and parallel between the top surface and the bottom surface and having widths that are arranged side by side across the second side surface.

2. The container of claim 1, further comprising:
the container being constructed entirely of plastic.

3. The container of claim 1, further comprising:
a rounded side corner surface extending between the top surface and the bottom surface and merging into the top surface and the bottom surface, the side corner surface separating the first side surface from the second side surface and merging into the first side surface and the second side surface.

4. The container of claim 1, further comprising:
a rounded first top corner surface extending across a top of the first side surface and merging the first side surface with the top surface; and,
a rounded second top corner surface extending across a top of the second side surface and merging the second side surface with the top surface.

5. The container of claim 4, further comprising:
the first and second top corner surfaces merging into the substantially flat surface area of the top surface.

6. The container of claim 4, further comprising:
a rounded first bottom corner surface extending across a bottom of the first side surface and merging the first side surface with the bottom surface; and,
a rounded second bottom corner surface extending across a bottom of the second side surface and merging the second side surface with the bottom surface.

7. The container of claim 6, further comprising:
the plurality of concave groove surface sections on the first side surface merging with the first top corner surface and the first bottom corner surface; and,
the plurality of convex rib surface sections on the second side surface merging with the second top corner surface and the second bottom corner surface.

8. The container of claim 1, further comprising:
the concave groove surface sections and the convex rib surface sections being complementary, wherein the convex rib surface sections of one container fit into the concave groove surface sections of a second container.

9. The container of claim 1, further comprising:
a neck projecting out from the top surface, the neck surrounding an opening to an interior of the container, the substantially flat surface area of the top surface surrounding the neck;
an interior wall projecting into the bottom surface, the interior wall surrounding a cavity recessed into the bottom surface, the substantially flat surface area of the bottom surface surrounding the cavity; and,
the neck of a first container and the cavity of a second container being dimensioned wherein the neck of the first container fits into the cavity of the second container with the substantially flat surface area of the bottom surface of the second container engaging on top of the substantially flat surface area of the top surface of the first container.

10. The container of claim 1, further comprising:
the plurality of side surfaces being four side surfaces that extend between the top surface and the bottom surface; and,
the top surface, bottom surface and four side surfaces together defining a cubic configuration of the container.

11. A pourable product container comprising:
a top surface having a cylindrical neck projecting from the top surface, the neck surrounding an opening to an interior of the container;
a bottom surface opposite the top surface;
four side surfaces extending between the top surface and the bottom surface, two of the side surfaces having pluralities of concave groove surface sections having widths arranged side by side across the two side surfaces and lengths extending across the two side surfaces between the top surface and the bottom surface; and,
an other two of the side surfaces having pluralities of convex rib surface sections having widths arranged side by side across the other two side surfaces and lengths extending across the other two side surfaces between the top surface and the bottom surface.

12. The container of claim 11, further comprising;
four rounded top corner surfaces merging with the top surface and arranged end to end in a substantially rectangular configuration around the top surface; and,
each of the four side surfaces merging with one of the four top corner surfaces.

13. The container of claim 12, further comprising:
the pluralities of concave groove surface sections merging with the top corner surfaces; and,
the pluralities of convex rib surface sections merging with the top corner surfaces.

14. The container of claim 12, further comprising:
four rounded bottom corner surfaces merging with the bottom surface and arranged end to end in a substantially rectangular configuration around the bottom surface; and,
each of the four side surfaces merging with one of the four bottom corner surfaces.

15. The container of claim 14, further comprising:
the pluralities of concave groove surface sections merging with the top corner surfaces and the bottom corner surfaces; and,
the pluralities of convex rib surface sections merging with the top corner surfaces and the bottom corner surfaces.

16. The container of claim 11, further comprising:
the concave groove surface sections and the convex rib surface sections being complementary wherein the convex rib surface sections of a first container fit into the concave groove surface sections of a second container.

17. The container of claim 11, further comprising:
the top surface, the bottom surface and the four side surfaces together define a cubic configuration of the container.

18. The container of claim 11, further comprising:
a substantially flat surface area on the top surface surrounding the neck;
a cylindrical interior wall projecting into the bottom surface, the interior wall surrounding a cavity recessed into the bottom surface, a substantially flat surface area on the bottom surface surrounding the cavity; and,
the neck of a first container and the cavity of a second container being dimensioned wherein the neck of the first container fits into the cavity of the second container with the substantially flat surface area of the bottom surface of the second container engaging on top of the substantially flat surface area of the top surface of the first container.

19. A method of arranging pourable product containers in a tight fit three dimensional array, the method comprising:
providing each container of a plurality of containers with a cubic configuration having a top surface, an opposite bottom surface and four side surfaces that extend between the top surface and the bottom surface;
providing two of the side surfaces of each of the plurality of containers with concave groove surface sections having widths arranged side by side across the two side surfaces and lengths extending across the two side surfaces between the top surface and the bottom surface;
providing an other two of the side surfaces of each container with pluralities of convex rib surface sections having widths arranged side by side across the other two side surfaces and lengths extending across the other two side surfaces between the top surface and the bottom surface;
arranging the plurality of containers in a plurality of two dimensional arranged layers with the concave groove surface sections and the convex rib surface sections of adjacent containers in complementary engagement in each layer; and,
stacking the pluralities of layers and arranging the containers in the three dimensional array.

20. The method of claim 19 further comprising:
providing the top surface of each container with a cylindrical neck projecting from the top surface, the cylindrical neck surrounding an opening to an interior of the container;
providing a cylindrical interior wall projecting into the bottom surface of each container, the interior wall surrounding a cavity recessed into the bottom surface of each container; and,
stacking a first layer of containers on top of a second layer of containers by positioning the bottom surfaces of the containers in the first layer on top of and in engagement with the top surfaces of the containers in the second layer with the necks of the containers in the second layer extending into the cavities of the containers in the first layer.

21. The method of claim 19, further comprising:
providing the top surface of each container with a substantially flat surface area surrounding the neck of the container;
providing the bottom surface of each container with a substantially flat surface area surrounding the cavity in the bottom surface of the container; and, stacking a first layer of containers on top of a second layer of containers by positioning the substantially flat surface areas on the bottom surfaces of the first layer of containers on top of and in engagement with the substantially flat surface areas on the top surfaces of the second layer of containers.
